(19) United States
(12) Patent Application Publication
(10) Pub. No.: US 2012/0146842 A1
(43) Pub. Date: Jun. 14, 2012

(54) RF TRANSCEIVER FOR RADAR SENSOR

(75) Inventor: Dong Min KANG, Daejeon (KR)

(73) Assignee: ELECTRONICS AND TELECOMMUNICATIONS RESEARCH INSTITUTE, Daejeon (KR)

(21) Appl. No.: 13/244,039

(22) Filed: Sep. 23, 2011

(30) Foreign Application Priority Data
Dec. 13, 2010 (KR) 10-2010-0126896

(51) Int. Cl. G01S 13/00

(52) U.S. Cl. 342/175

(57) ABSTRACT

An RF transceiver for radar sensors of microwave and millimeter wave bands, and an RF transceiver for a radar sensor which uses a monolithic microwave integrated circuit of core components and includes SP3T switches, Rotman lenses, and a transmitting five-patch array antenna and a receiving five-patch array antenna of a transmitting unit and a receiving unit. Smoother beam scanning with three beams is performed using the patch array antennas, the Rotman lenses, and the switches. The structure of the transceiver is configured in a homodyne scheme. A double balanced mixer is applied to improve separation characteristics between transmission and reception signals. Positive components such as the patch array antennas, the Rotman lenses, the switches, and an amplifier are configured on a single substrate.

### CROSS-REFERENCE TO RELATED APPLICATIONS

This application is based on and claims priority from Korean Patent Application No. 10-2010-0126896, filed on Dec. 13, 2001, with the Korean Intellectual Property Office, the present disclosure of which is incorporated herein in its entirety by reference.

### TECHNICAL FIELD

The present disclosure relates to an RF transceiver for a radar sensor, and more particularly, to an RF transceiver for a radar sensor to which a homodyne scheme that is a simple structure is applied and which improves a separation characteristics between transmission and reception signals.

### BACKGROUND

Radar is an apparatus that transmits a microwave to a target object, receives a reflected wave thereof, and projects the state and position of the object onto an image receiving tube, thereby detecting the target object. For radar systems, array antennas have been used for the formation of sharply directive beams. Array antenna characteristics are determined by the geometric position of radiator elements and the amplitude and phase of their individual excitations. Radar developments, such as a magnetron and other high powered microwave transmitters, resulted in an effect in that a rise in commonly used radar frequency is accelerated. At those higher frequencies, simpler antennas are of practical use, and as such a simpler antenna, a parabolic reflector illuminated by horn feed or other simple primary antenna is generally used.

Electronic scanning (inertialess) became important for a number of reasons, including scanning speed and the capability for random or programmed beam focusing. Because of the development of electronically controlled phase shifters and switches, attention has been redirected toward the array type antenna in which each radiating element can be individually and electronically controlled. Controllable phase shifting devices in the phased array art provides the capability for rapidly and accurately switching beams and thus permits radar to perform multiple functions interlaced in time, or even simultaneously.

Typically, an RF transceiver for a radar sensor is generally divided into a signal source using a voltage controlled oscillator (VCO), a transmitting unit for transmitting a transmission modulation power, and a receiving unit for transmitting a reception signal. A transmission modulation signal transmitted from the transmitting unit is divided into two signals through a coupler, one of the two signal is radiated as a carrier through a transmission antenna to the outside, and the other signal is input as a local oscillation signal LO to a mixer of the receiving unit[K1]. Such a transceiver is called a homodyne RF transceiver.

However, since the transmission modulation signal influences the reception signal, such that the separation characteristics of the receiving unit is degraded, the receiving sensitivity of the homodyne RF transceiver is reduced, such that the high-sensitivity reception of a radar sensor is difficult[K2]. Meanwhile, the heterodyne RF transceiver is superior in the separation characteristics of the transmitting unit and the receiving unit, but is structurally complex.

Therefore, it is desperately required to develop an RF transceiver for a radar sensor which is superior in the separation characteristics of a transmitting unit and a receiving unit while using the homodyne scheme that is a simple structure.

### SUMMARY

The present disclosure has been made in an effort to provide an RF transceiver for a radar sensor which is structurally simple as compared to a heterodyne scheme, and can improve separation between transmission and reception signals.

Further, the present disclosure has been made in an effort to provide an RF transceiver for a radar sensor which is structurally simple by implementing patch array antennas, Rotman lenses, and SP3T switches on a single substrate for beam scanning.

An exemplary embodiment of the present disclosure provides an RF transceiver for a radar sensor, including: a voltage controlled oscillator for generating an RF signal; a signal divider for dividing a power of the generated RF signal for a transmission side and a reception side; a transmitting switch for switching a divided output for the transmission side from the signal divider as a plurality of output signals; a transmitting Rotman lens for performing beamforming on the output signals switched by the transmitting switch; a transmitting micro strip patch array antenna connected to each port of the transmitting Rotman lens and configured to radiate the signals subjected to the beamforming; a receiving microstrip patch array antenna for receiving RF signals through a wireless space; a receiving Rotman lens for performing beamforming on the signals received through the receiving microstrip patch array antenna; a receiving switch for switching the plurality of reception signals subjected to the beamforming through the receiving Rotman lens; and a mixer for mixing the reception signals output through the receiving switch and an output divided for a reception side by a signal divider.

Another exemplary embodiment of the present disclosure provides an RF transmitter for a radar sensor, including: a voltage controlled oscillator for generating an RF signal; a signal divider for dividing a power of the generated RF signal for a transmission side and a reception side; a switch for switching a divided output for the transmission side from the signal divider as a plurality of output signals; a Rotman lens for performing beamforming on the output signals switched by the switch; and a microstrip patch array antenna connected to each port of the Rotman lens and configured to radiate the signals subjected to the beamforming.

Yet another exemplary embodiment of the present disclosure provides an RF receiver for a radar sensor, including: a microstrip patch array antenna for receiving RF signals through a wireless space; a Rotman lens for performing beamforming on the signals received through the microstrip patch array antenna; a switch for switching the plurality of reception signals subjected to the beamforming through the Rotman lens; and a mixer for mixing the reception signals output through the switch and an output divided for a reception side by a signal divider of a transmitter.

The RF transceiver for a radar sensor according to the exemplary embodiment of the present disclosure is structurally very simple as compared to a heterodyne transceiver having a complex structure according to the related art, and is superior in separation characteristics between the transmission and reception signals.

Further, the switches, the Rotman lenses, and the patch array antennas are configured on a single substrate of a transceiver to steer three beams for beam scanning, such that the manufacturing cost and development period can be reduced.

In addition, the exemplary embodiments of the present disclosure are applicable to existing radar sensors of microwave and millimeter wave bands, and so on.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a configuration of an RF transceiver for a radar sensor according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

An exemplary embodiment of the present disclosure proposes an RF transceiver for a radar sensor to which a homodyne scheme that is a simple structure as compared to the heterodyne scheme is applied, and which improves the separation characteristics between transmission and reception signals.

To this end, in exemplary embodiments of the present disclosure, a double balanced mixer superior in the separation characteristics is used as a mixer which is a signal mixer. Also, according to the exemplary embodiments of the present disclosure, for beam scanning, SP3T switches, Rotman lenses, and patch array antennas are disposed on a single substrate.

Typically, an RF transceiver for a radar sensor is generally divided into a signal source using a voltage controlled oscillator (VCO), a transmitting unit for transmitting a transmission modulation power, and a receiving unit for transmitting a reception signal. In this case, a transmission modulation signal transmitted from the transmitting unit is divided into two signals by a divider, one of the two signals[K3] is radiated as a carrier to the outside through a transmission antenna to the outside and the other signal is input as a local oscillation signal LO to a mixer of the receiving unit. In this homodyne transceiver, since the transmission modulation signal influences the reception signal, such that the separation characteristics of the receiving unit is degraded, the receiving sensitivity is reduced, such that the high-sensitivity reception of a radar sensor is difficult[K4]. For this reason, the exemplary embodiments of the present disclosure propose a homodyne RF transceiver capable of achieving a performance improvement of the receiving sensitivity.

Hereinafter, the exemplary embodiments of the present disclosure will be described in detail with reference to the accompanying drawings. Configurations of the exemplary embodiments of the present disclosure and effects attained thereby will be clearly understood from the following description. Prior to proceeding to a more detailed description of the present disclosure, it should be noted that identical components are denoted by the same symbol throughout the drawings and a detailed description of well-known components that may make the gist of the present disclosure unclear will be omitted.

An RF transceiver for a radar sensor according to an exemplary embodiment of the present disclosure includes a double balanced mixer configured as a mixer of a receiving unit for improving a separation characteristics between a transmission signal output from a transmitting unit through a signal divider and a reception signal received through an antenna of the receiving unit, and 5-channel patch array antennas, Rotman lenses, and switches configured to steer three beams for beam scanning. As such, positive components including the antennas, the Rotman lenses, the switches, and an amplifier are configured on a single substrate, resulting in a simple structure.

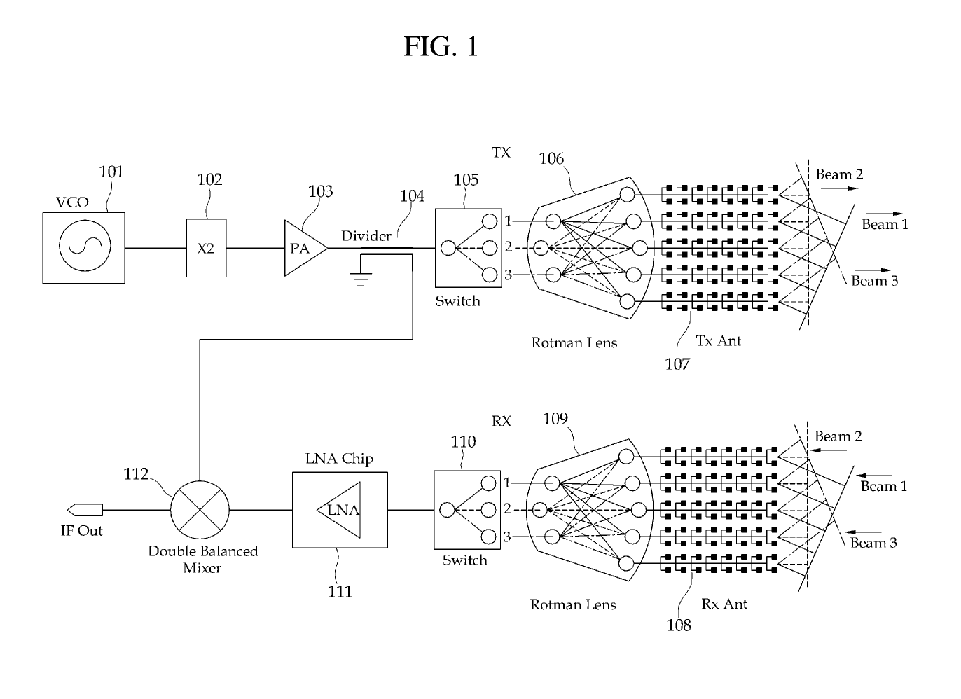

FIG. 1 is a view illustrating a configuration of an RF transceiver for a radar sensor according to an exemplary embodiment of the present disclosure. At an output terminal of voltage controlled oscillator (hereinafter, referred to as ‘VCO’) 101 that is a signal source generating an RF signal, a frequency multiplier 102 is disposed for multiplying an oscillation frequency of VCO 101 by two. At an output terminal of frequency multiplier 102, a power amplifier 103 is positioned for power amplification.

At an output terminal of power amplifier 103, a signal divider 104 is disposed for power division. At one of outputs of signal divider 104, a transmission SP3T switch 105 is disposed. At output terminals of switch 105, a transmission Rotman lens 106 capable of performing beamforming on three beams is disposed. At each port of Rotman lens 106, a microstrip patch array antenna 107 is disposed.

Meanwhile, another divided signal from signal divider 104 is supplied as a local oscillator (LO) signal to a double balanced mixer 112 of a receiving unit[K5].

In the receiving unit, a receiving Rotman lens 109 is disposed to perform beamforming on signals received through a receiving microstrip patch array antenna 108, and a receiving switch 110 is disposed to switch three reception signals subjected to the beamforming. The reception signal passing through switch 110 is input to low-noise amplifier 111 capable of low-noise and high-gain amplification, and the reception signal subjected to the low-noise and high-gain amplification in low-noise amplifier 111 is input to double balanced mixer 112 which is superior in the separation characteristics between transmission and reception signals, together with the LO signals supplied from the transmitting unit[K6]. The reception signal passing through double balanced mixer 112 is converted into an intermediate frequency which is input to a signal analyzer (not shown).

Hereinafter, a detailed operation of the transceiver will be described. VCO 101 is a signal source generating an RF signal, and may be formed of a microwave monolithic integrated circuit (MMIC) or a Gunn diode. A modulated and oscillated transmission signal from VCO 101 is transmitted to frequency multiplier 102 that multiplies the frequency of the input modulated and oscillated transmission signal by two. Frequency multiplier 102 should be superior in the suppression characteristic of f₀ with respect to 2f₀ and an input/output matching characteristic.

The multiplied transmission signal is transmitted to power amplifier 103 for correction on a conversion loss in frequency multiplier 102 and power amplification. The power-amplified transmission signal is divided to be supplied to the antenna of the transmitting unit and be supplied as the LO signal to the mixer of the receiving unit (that is, double balanced mixer 112). The divided signal for the antenna of the transmitting unit is input to switch 105 of the transmitting unit for beam scanning.

Switch 105 may be a single pole triple throw (SP3T) switch for controlling three beams, and a switching speed is controlled through a switch controller (not shown). As shown in FIG. 1, the divided signal for the antenna of the transmitting unit is switched to first, second, and third output terminals of switch 105, and the switched signals are input to Rotman lens 106 for scanning with three beams[K7]. Rotman lens 106 performs beamforming on the three switched signals, and patch array antenna 107 radiates beam patterns Beam1, Beam2, and Beam3, as shown in FIG. 1.

Meanwhile, since the antenna gain of microstrip patch array antenna 107 increases as the number of arranged antenna lines increases, according to specifications of a system, microstrip patch array antenna 107 is designed and the optimal number of arranged antenna lines is determined [K8]. Patch array antenna 107 radiates the transmission signal in three beam patterns under the control of switch 105.

The other output of signal divider 104 is directly connected to an LO terminal of a down mixer (that is, double balanced mixer 112) of the receiving unit, unlike a heterodyne transceiver according to the related art. In the receiving unit, three signals received through receiving patch array antenna 108 having five microstrip patches pass through Rotman lens 109 for beamforming, and the three reception signals subjected to the beamforming are input to low-noise amplifier 111 through switch 110[K9]. The signals received through the receiving antenna [K10] are subjected to low-noise amplification through low-noise amplifier 111.

Then, a Doppler reception signal of 2f₀+δf is transmitted to an RF terminal of double balanced mixer 112, and is mixed with the LO signal having a bandwidth of 2f₀ transmitted to the LO terminal of the down mixer so as to be converted into an IF signal, and the IF signal is transmitted to a DSP (not shown)[K11]. Here, δf means a reception-frequency shift width by a Doppler effect[K12]. Meanwhile, according to the exemplary embodiment of the present disclosure, in order to improve the separation between the transmission signals and the reception signals, double balanced mixer 112 superior in the separation characteristics is applied as the down mixer, so as to achieve the considerably superior separation characteristics. If the separation between the transmission and reception signals becomes superior, interference between a transmission signal frequency and a reception signal frequency very close to each other does not occur, such that the receiving sensitivity of a receiver becomes outstandingly superior.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An RF transmitter for a radar sensor, comprising:
a voltage controlled oscillator for generating an RF signal;
a signal divider for dividing a power of the generated RF signal for a transmission side and a reception side;
a switch for switching a divided output for the transmission side from the signal divider as a plurality of output signals;
a Rotman lens for performing beamforming on the output signals switched by the switch; and
a microstrip patch array antenna connected to each port of the Rotman lens and configured to radiate the signals subjected to the beamforming.

2. The RF transmitter for a radar sensor of claim 1, wherein any one or more selected from the voltage controlled oscillator, the signal divider, the switch, the Rotman lens, and the microstrip patch array antenna are configured as a microwave monolithic integrated circuit (MMIC).

3. The RF transmitter for a radar sensor of claim 1, further comprising:
a frequency multiplier for multiplying the RF signal[K13] of the voltage controlled oscillator by an integer.

4. The RF transmitter for a radar sensor of claim 3, further comprising:
a power amplifier for amplifying a power of an output signal of the frequency multiplier.

5. The RF transmitter for a radar sensor of claim 1, further comprising:
the voltage controlled oscillator is formed of a Gunn diode.

6. An RF receiver for a radar sensor, comprising:
a microstrip patch array antenna for receiving RF signals through a wireless space;
a Rotman lens for performing beamforming on the signals received through the microstrip patch array antenna;
a switch for switching the plurality of reception signals subjected to the beamforming through the Rotman lens; and
a mixer for mixing the reception signals output through the switch and an output divided for a reception side by a signal divider of a transmitter.

7. The RF receiver for a radar sensor of claim 6, wherein the mixer is a double balanced mixer.

8. The RF receiver for a radar sensor of claim 6[K14], further comprising:
a low-noise amplifier for performing low-noise and high-gain amplification on the reception signals output through the switch.

9. The RF receiver for a radar sensor of claim 6[K15], wherein any one or more selected from the microstrip patch array antenna, the Rotman lens, the switch, and the mixer are configured as a microwave monolithic integrated circuit (MMIC).
